(19) United States
(12) Patent Application Publication
(10) Pub. No.: US 2004/0058116 A1
(43) Pub. Date: Mar. 25, 2004

(54) Tacky dust cleaner

(75) Inventors: Masanori Sano, Ibaraki-shi (JP); Yasuhiko Kawaguchi, Ibaraki-shi (JP); Masanori Uesugi, Ibaraki-shi (JP); Takashi Kamada, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/663,682

(22) Filed: Sep. 17, 2003

(30) Foreign Application Priority Data
Sep. 25, 2002 (JP) P. 2002-279402

(51) Int. Cl. B32B 9/00

(52) U.S. Cl. 428/40.1; 15/104.002; 428/343

(57) ABSTRACT

A tacky dust cleaner has an expanded pressure-sensitive adhesive layer, the expanded pressure-sensitive adhesive layer being constituted of a pressure-sensitive adhesive containing (A) an acrylic polymer containing an isocyanate group-reactive functional group, (B) a polyisocyanate based compound, (C) thermally expandable microspheres, and (D) an amine based compound containing plural hydroxyl groups.

### FIELD OF THE INVENTION

The present invention relates to a tacky dust cleaner.

### BACKGROUND OF THE INVENTION

In a tacky dust cleaner having a configuration where it is wound such that a pressure-sensitive adhesive layer becomes outside, there have hitherto been known various tacky dust cleaners having an expanded pressure-sensitive adhesive layer where a pressure-sensitive adhesive layer is expanded (see Japanese Patent Laid-Open 100224/1986 and Japanese Utility Model Registration No. 2,530,113).

Now, in the case where an acrylic pressure-sensitive adhesive composed mainly of an acrylic polymer (acrylic polymer) is used as a pressure-sensitive adhesive constituting an expanded pressure-sensitive adhesive layer, for enhancing cohesion of the pressure-sensitive adhesive layer, a crosslinking agent capable of causing a crosslinking reaction with the acrylic polymer is usually used. As described above, in the case where an acrylic polymer is used as a pressure-sensitive adhesive constituting an expanded pressure-sensitive adhesive layer, a two-stage process was necessary. That is, a pressure-sensitive adhesive solution having an acrylic polymer, a crosslinking agent, and thermally expandable microcapsules as a heat foaming agent compounded therein (usually, these materials are dissolved in a solvent such as toluene and ethyl acetate) is coated on a substrate; the pressure-sensitive adhesive layer is dried at a temperature at which the thermally expandable microcapsules do not cause expansion (usually, at from 80 to 90° C.); after drying, a separator is laminated on the pressure-sensitive adhesive layer, and the assembly is once wound up; the wound assembly is aged for several days as it stands; and after the aging treatment, the wound tacky tape is again unwound and brought into contact with heat rollers to expand the pressure-sensitive adhesive layer, followed by winding up. The reason why the aging treatment is necessary resides in the matter that if an expansion process (expansion treatment) of the pressure-sensitive adhesive layer is not carried out after the crosslinking reaction between the acrylic polymer and the crosslinking agent proceeds to some extent (after elapse of about 4 days at normal temperature), an excessive pressure is applied to the pressure-sensitive adhesive layer during the expansion processing, thereby affecting the surface state of the pressure-sensitive adhesive layer, resulting in possibly causing the case where the desired characteristics are not obtained.

Accordingly, so far, an aging treatment time for making the crosslinking reaction of the crosslinking agent proceed was necessary, productivity was low, and costs were high.

Also, the aging treatment is carried out in the state where a tacky tape is wound in a rolled state. In this case, there may be the case of causing scatters in characteristics of the pressure-sensitive adhesive layer, which are considered to occur due to a difference in degree of progress of the crosslinking reaction between a center (a site closed to a core) and an outer periphery of the tacky tape roll, leading to possible influences against characteristics of final products.

### SUMMARY OF THE INVENTION

An object of the invention is to provide a tacky dust cleaner that can be produced with high productivity and at low costs.

Another object of the invention is to provide a tacky dust cleaner having good quality characteristics.

In order to attain the foregoing objects, the present inventors made extensive and intensive investigations. As a result, it has been found that when specific components are used as respective components constituting an expanded pressure-sensitive adhesive layer, a sufficient crosslinking reaction can proceed only by a drying step after coating of a pressure-sensitive adhesive, and even when subsequently (on the same production line without carrying out an aging treatment), an expansion step of the pressure-sensitive adhesive layer is carried out, it is possible to expand the pressure-sensitive adhesive layer in a good state, and also, quality characteristics are good as a final dust cleaner. The invention has been accomplished on a basis of such finding.

Specifically, the invention provides a tacky dust cleaner having an expanded pressure-sensitive adhesive layer, the expanded pressure-sensitive adhesive layer being constituted of a pressure-sensitive adhesive comprising (A) an acrylic polymer containing an isocyanate group-reactive functional group, (B) a polyisocyanate based compound, (C) thermally expandable microspheres, and (D) an amine based compound containing plural hydroxyl groups.

The foregoing expanded pressure-sensitive adhesive layer may be formed on at least one surface of a substrate. It is preferred that an antistatic layer is formed between the expanded pressure-sensitive adhesive layer and the substrate.

It is preferred that the tacky dust cleaner has a rolled state where it is wound around a core such that the expanded pressure-sensitive adhesive layer becomes outside.

### BRIEF DESCRIPTION OF THE DRAWINGS

FIG. 1 is a schematic sectional view to partially show one embodiment of the tacky dust cleaner of the invention.

FIGS. 2A, 2B, 2C and 2D are schematic views to show embodiments of using the tacky dust cleaner of the invention.

### DESCRIPTION OF REFERENCE NUMERALS AND SIGNS

1: Tacky dust cleaner

2: Expanded pressure-sensitive adhesive layer

3: Antistatic layer

4: Substrate

1a to 1d: Tacky dust cleaner

5a to 5d: Stain-attached material

6a: Rubber roller or metallic roller

6b, 6c: Tacky rubber roller

### DETAILED DESCRIPTION OF THE INVENTION

In the tacky dust cleaner of the invention, the pressure-sensitive adhesive constituting the expanded pressure-sensitive adhesive layer contains (A) an acrylic polymer containing an isocyanate group-reactive functional group (hereinafter sometimes referred to as “acrylic polymer (A)”), (B) a polyisocyanate based compound (hereinafter sometimes referred to as “isocyanate based compound (B)”), (C) thermally expandable microspheres, and (D) an amine based compound containing plural hydroxyl groups (hereinafter sometimes referred to as “amine based compound (D)”). In the pressure-sensitive adhesive, the acrylic polymer (A) can be used as a base polymer; the isocyanate based compound (B) can be used as a crosslinking agent; the thermally expandable microspheres (C) can be used as a foaming agent; and the amine based compound (D) can be used as a crosslinking assistant.

[(A) Acrylic Polymer Containing an Isocyanate Group-Reactive Functional Group]

Any acrylic polymers containing at least one isocyanate group-reactive functional group (such as a carboxyl group, a hydroxyl group, and an amino group) in the molecule thereof can be used as the acrylic polymer (A) without particular limitations. As the acrylic polymer (A) , can be used copolymers comprising at least a (meth)acrylic acid alkyl ester and a copolymerizable monomer containing an isocyanate group-reactive functional group as monomer components. The acrylic polymer (A) can be used singly or in admixture of two or more thereof.

The (meth)acrylic acid alkyl ester is not particularly limited but is preferably a (meth)acrylic acid alkyl ester in which the alkyl moiety thereof has from 1 to 18 (preferably from 2 to 12) carbon atoms. Specific examples include (meth)acrylic acid alkyl esters such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, and dodecyl (meth)acrylate. These (meth)acrylic acid alkyl esters can be used singly in admixture of two or more thereof.

Examples of copolymerizable monomers containing an isocyanate group-reactive functional group include hydroxyl group-containing copolymerizable monomers, carboxyl group-containing copolymerizable monomers, amino group-containing copolymerizable monomers, and epoxy group-containing copolymerizable monomers. Above all, hydroxyl group-containing copolymerizable monomers and carboxyl group-containing copolymerizable monomers are preferably used. The copolymerizable monomers containing an isocyanate group-reactive functional group can be used singly or in admixture of two or more thereof.

The hydroxyl group-containing copolymerizable monomers are not particularly limited. Examples include hydroxyalkyl (meth)acrylates such as hydroxymethyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, and 6-hydroxyhexyl (meth)acrylate; vinyl alcohol; allyl alcohol; hydroxyalkyl vinyl ethers such as 2-hydroxyethyl vinyl ether, 3-hydroxypropyl vinyl ether, and 4-hydroxybutyl vinyl ether; hydroxyalkyl allyl ethers such as 2-hydroxyethyl allyl ether; hydroxyalkyl crotonates such as 2-hydroxyethyl crotonate; and methylolated (meth)acrylamide.

Examples of carboxyl group-containing copolymerizable monomers include (meth)acrylic acid (i.e., acrylic acid or methacrylic acid), itaconic acid, maleic acid, fumaric acid, crotonic acid, carboxyethyl acrylate, and carboxypentyl acrylate. The carboxyl group-containing copolymerizable monomers also include derivatives thereof (such as acid anhydride group-containing monomers such as maleic anhydride and itaconic anhydride).

Examples of amino group-containing copolymerizable monomers include aminoethyl (meth)acrylate, t-butylaminoethyl (meth)acrylate, aminopropyl (meth)acrylate, aminobutyl (meth)acrylate, and aminohexyl (meth)acrylate. Examples of epoxy group-containing copolymerizable monomers include glycidyl (meth)acrylate.

Also, in the invention, various monomers that are known as a modifying monomer of the acrylic pressure-sensitive adhesive may be used as the monomer component. Examples of modifying monomers include vinyl esters such as vinyl acetate, vinyl propionate, and vinyl butyrate; cyano group-containing copolymerizable monomers such as (meth)acrylonitrile; amide group-containing copolymerizable monomers such as (meth)acrylamide, N,N-dimethyl (meth)acrylamide, N,N-diethyl (meth)acrylamide, N-isopropyl (meth)acrylamide, and N-butyl (meth)acrylamide; (meth)acrylic acid alicyclic hydrocarbon esters such as cyclohexyl (meth)acrylate, bornyl (meth)acrylate, and isobornyl (meth)acrylate; (meth)acrylic acid aryl esters such as phenyl (meth)acrylate; vinyl group-containing heterocyclic compounds such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, and vinyl-morpholine; and N-vinylcarboxylic acid amides. The modifying monomers can be used singly or in admixture of two or more thereof.

In addition, in the invention, copolymerizable monomers other than those described above, such as olefins such as ethylene and propylene; dienes such as isoprene, butadiene, and isobutylene; alkoxy group-containing copolymerizable monomers such as methoxyethyl (meth)acrylate and ethoxyethyl (meth)acrylate; halogen atom-containing vinyl monomers such as vinyl chloride and vinylidene chloride; vinyl ethers such as methyl vinyl ether and ethyl vinyl ether; and styrene based monomers such as styrene and vinyltoluene, may be used as the monomer component.

As the polymerization method for obtaining the acrylic polymer (A), there can be employed customary polymerization methods such as a solution polymerization method of performing polymerization using a polymerization initiator such as azo based compounds and peroxides, an emulsion polymerization method, a bulk polymerization method, and a polymerization method of performing polymerization using a photo initiator upon irradiation with light or radiations. In the invention, a method of performing polymerization using a polymerization initiator capable of generating radicals upon decomposition (radical polymerization method) can suitably be employed. In such radical polymerization, polymerization initiators that are used in usual radical polymerization can be used. For example, peroxides such as dibenzoyl peroxide and tertbutyl permaleate, and azo based compounds such as 2,2′-azobisisobutyronitrile and azobisisovaleronitrile are used.

In the radical polymerization, the amount of the polymerization initiator to be used may be an amount that is usually used in the polymerization of acrylic monomers. For example, the amount of the polymerization initiator is from about 0.005 to 10 parts by weight, and preferably from about 0.1 to 5 parts by weight based on 100 parts by weight of the total sum of the foregoing monomer components (such as (meth)acrylic acid alkyl esters and copolymerizable monomers containing an isocyanate group-reactive group).

In the invention, in the acrylic polymer (A) obtained by polymerization using the foregoing monomer components (such as (meth)acrylic acid alkyl esters, copolymerizable monomers containing an isocyanate group-reactive group, and modifying monomers), the (meth) acrylic acid alkyl ester is usually used as the major component. Accordingly, in the acrylic polymer (A), the proportion of the (meth)acrylic acid alkyl ester can be selected within the range of, for example, about 50% by mole or more (from about 50 to 99.9% by mole), preferably about 55% by mole or more (from about 55 to 99.8% by mole) , and more preferably about 60% by mole or more (from about 60 to 99.5% by mole) based on the total sum of the monomer components.

Also, the proportion of the copolymerizable monomer containing an isocyanate group-reactive group can be selected within the range of, for example, not more than about 20% by mole (from about 20 to 0.001% by mole), preferably not more than about 10% by mole (from about 10 to 0.02% by mole), and more preferably not more than about 5% by mole (from about 5 to 0.03% by mole).

The molecular weight (weight average molecular weight, etc.) of the acrylic polymer (A) is not particularly limited. The weight average molecular weight of the acrylic polymer (A) can be selected within the range of, for example, about 50,000 or more (from about 50,000 to 3,000,000), preferably from about 200,000 to 2,000,000, and more preferably from about 300,000 to 1,500,000.

Incidentally, in the invention, acrylic polymers containing a reactive functional group other than the isocyanate group-reactive functional group may be used together with the acrylic polymer (A) as a base polymer.

The term “(meth)acrylic” as used herein refers to “acrylic and/or methacrylic”, the term “(meth)acrylate” as used herein refers to “acrylate and/or methacrylate”, the term “(meth)acrylo-” as used herein refers to “acrylo- and/or methacrylo-”, and the term “(meth)acrylamide” as used herein refers to “acrylamide and/or methacrylamide”.

[(B) Polyisocyanate Based Compound]

Any isocyanate based compounds having at least two isocyanate groups in the molecule thereof can be used as the isocyanate based compound (B) without particular limitations. Examples of the isocyanate based compound (B) include aliphatic polyisocyanates, alicyclic polyisocyanates, aromatic polyisocyanates, and aromatic aliphatic polyisocyanates. The isocyanate based compound (B) can be used singly or in admixture of two or more thereof.

Examples of the foregoing aliphatic polyisocyanates include aliphatic diisocyanates such as 1,6-hexamethylene diisocyanate, 1,4-tetramethylene diisocyanate, 2-methyl-1,5-pentane diisocyanate, 3-methyl-1,5-pentane diisocyanate, and lysine diisocyanate.

Also, examples of the alicyclic polyisocyanates include alicyclic diisocyanates such as isophorone diisocyanate, cyclohexyl diisocyanate, hydrogenated tolylene diisocyanate, hydrogenated xylene diisocyanate, hydrogenated diphenylmethane diisocyanate, and hydrogenated tetramethylxylene diisocyanate.

Examples of the aromatic polyisocyanates include aromatic diisocyanates such as 2,4-tolylene diisocyanate, 2,6-tolylene diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, and 3,3′-dimethoxydiphenyl-4,4′-diisocyanate.

Examples of the aromatic aliphatic polyisocyanates include aromatic aliphatic diisocyanates such as xylylene-1,4-diisocyanate and xylylene-1,3-diisocyanate.

Further, dimers or trimers, reaction products and polymers of the above enumerated aliphatic polyisocyanates, alicyclic polyisocyanates, aromatic polyisocyanates and aromatic aliphatic polyisocyanates (such as a dimer or trimer of diphenylmethane diisocyanate, a reaction product between trimethylolpropane and tolylene diisocyanate, a reaction product between trimethylolpropane and hexamethylene diisocyanate, polymethylene polyphenyl isocyanate, polyether polyisocyanates, and polyester polyisocyanates) can also be used as the isocyanate based compound (B).

Incidentally, in the invention, crosslinking agents other than the polyisocyanate based compound (such as polyfunctional melamine compounds and polyfunctional epoxy compounds) can be used together with the polyisocyanate based compound (B).

[(C) Thermally Expandable Microspheres]

Any particles having a function to cause an expansion phenomenon under an established heating condition can be used as the thermally expandable microspheres (C) without particular limitations. More specifically, microspheres (microcapsules) having a substance that readily vaporize and expands upon heating (such as volatile gases such as low-boiling hydrocarbons including isobutane, propane, and pentane) encapsulated within an elastic shell can suitably be used as the thermally expandable microspheres. In many cases, the foregoing shell is formed of a heat fusible substance or a substance that is broken upon heat expansion. Examples of substances capable of forming the foregoing shell include vinylidene chloride-acrylonitrile copolymers, polyvinyl alcohols, polyvinylbutyrals, polymethyl methacrylates, polyacrylonitriles, polyvinylidene chlorides, polysulfones, methyl methacrylate-acrylonitrile copolymers, and methyl methacrylate-acrylonitrile-methylolacrylamide copolymers. The thermally expandable microspheres can be prepared by known or customary methods (such as coacervation method, interfacial polymerization method, and in situ polymerization method).

The expansion initiation temperature of the thermally expandable microspheres (C) can be selected within the range of from 80° C. to 210° C. In particular, it is desired to properly select and use the thermally expandable microspheres (C) that complete expansion at a temperature set up within the temperature range of from 80° C. to 120° C. corresponding to the preparation condition, etc.

Incidentally, ones having an expansion ratio of from about 10 to 50 times can suitably be used as the thermally expandable microspheres (C).

The thermally expandable microspheres (C) can be used singly or in admixture of two or more thereof. Incidentally, commercially available products such as “Matsumoto Microsphere” Series that are a trade name of Matsumoto Yushi-Seiyaku Co., Ltd. (such as a trade name “Matsumoto Microsphere F301D”); and “051DU”, “053DU”, “551DU”, “551-20DU” and “551-80DU”, all of which are a trade name of Expancel Inc., can be used as the thermally expandable microspheres (C).

[(D) Amine Based Compound Containing Plural Hydroxyl Groups]

Any amine compounds containing at least two hydroxyl groups (alcoholic hydroxyl groups) in the molecule thereof can be used as the amine based compound (D) without particular limitations. Also, in the amine based compound (D) , the number of nitrogen atoms to be contained in the molecule is not particularly limited. The amine based compound (D) can be used singly or in admixture of two or more thereof.

Specifically, in the amine based compound (D), examples of the amine based compound (D) containing one nitrogen atom in the molecule thereof include dialcoholamines such as diethanolamine, dipropanolamine, diisopropanolamine, N-methyldiethanolamine, N-methyldiisopropanolamine, N-ethyldiethanolamine, N-ethyldiisopropanolamine, N-butyldiethanolamine, and N-butyldiisopropanolamine; and trialcoholamines such as triethanolamine, tripropanolamine, and triisopropanolamine.

Also, examples of the amine based compound (D) containing two nitrogen atoms in the molecule thereof include amine based compounds represented by the following formula (1).

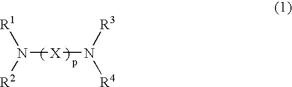

In the formula (1) , R¹, R², R³, and R⁴ may be the same or different and each represents a hydrogen atom or [—(R⁵O)ₘ(R⁶O)ₙ—H]. Here, R⁵ and R⁶ are different and each represents an alkylene group. m and n each represents an integer of 0 or more but do not represent 0 at the same time. Further, two least two of R¹, R², R³, and R⁴ represent [—(R⁵O)ₘ(R⁶O)ₙ—H]. Moreover, X represents a divalent hydrocarbon group, and p represents an integer of 1 or more.

In the formula (1), examples of the alkylene group represented by R⁵ and R⁶ include alkylene groups having from about 1 to 6 carbon atoms (preferably alkylene groups having from 1 to 4 carbon atoms, and more preferably alkylene groups having 2 or 3 carbon atoms) such as methylene, ethylene, propylene, trimethylene, tetramethylene, ethylethylene, pentamethylene, and hexamethylene groups. The alkylene group may have any of a linear form or a branched form. As the alkylene group represented by R⁵ and R⁶, an ethylene group and a propylene group can suitably be used.

Also, any integers of 0 or more can be employed as m and n without particular limitations. For example, at least one of m and n can be selected within the range of from about 0 to 20, and preferably from about 1 to 10. In many case, at least one of m and n is 0, and the other is an integer of 1 or more (especially 1). Incidentally, m and n do not represent 0 at the same time. However, the case where m and n represent 0 at the same time will mean the case where all of R¹ to R⁴ represent a hydrogen atom.

X represents a divalent hydrocarbon group. Examples of the divalent hydrocarbon group include alkylene groups, cycloalkylene groups, and arylene groups. The alkylene groups of X may be linear or branched and may be saturated or unsaturated. Examples of alkylene groups of X include alkylene groups having from about 1 to 6 carbon atoms (preferably alkylene groups having from 1 to 4 carbon atoms, and more preferably alkylene groups having 2 or 3 carbon atoms) such as methylene, ethylene, propylene, trimethylene, and tetramethylene groups. Also, examples of cycloalkylene groups include cycloalkylene groups having from about 5 to 12 members, such as a 1,2-cyclohexylene group, a 1,3-cyclohexylene group, and 1,4-cyclohexylene group. Examples of arylene groups include a 1,2-pheylene group, a 1,3-phenylene group, and a 1,4-phenylene group.

Also, any integers of 1 or more can be employed as p without particular limitations. For example, p can be selected within the range of from about 1 to 10, and preferably represents an integer of from 1 to 6, and more preferably an integer of from 1 to 4.

More specifically, examples of the amine based compound (D) represented by the foregoing formula (1) include N,N,N′,N′-tetrakis(2-hydroxyethyl)ethylenediamine, N,N,N′,N′-tetrakis(2-hydroxypropyl)ethylenediamine, N,N,N′,N′-tetrakis(2-hydroxyethyl)trimethylenediamine, N,N,N′,N′-tetrakis(2-hydroxypropyl)trimethylenediamine, and polyoxyalkylene condensates of alkylenediamines such as polyoxyethylene condensates of ethylenediamine, polyoxypropylene condensate of ethylenediamine, and polyoxyethylene-polyoxypropylene condensates of ethylenediamine. As such amine based compounds (D), commercially available products such as “EDP-300”, “EDP-450”, “EDP-1100”, and “Pluronic” (all of which are a trade name of Asahi Denka Co., Ltd.) can be utilized.

Incidentally, in the invention, amine based compounds containing plural reactive functional groups other than a hydroxyl group can also be used together with the amine based compound (D).

In the invention, as the proportions of the acrylic polymer (A), the isocyanate based compound (B) and the amine based compound (D) , for example, the content (M_{A}) (moles) of the isocyanate group-reactive functional group according to the acrylic polymer (A), the content (M_{B}) (moles) of the isocyanate group according to the isocyanate based compound (B), and the content (M_{D}) (moles) of the hydroxyl group according to the amine based compound (D) may have the following relationships.

(M_{D})/(M_{A})=from 0.01 to 100 (preferably from 0.03 to 50, and more preferably from 0.05 to 20)

(M_{B})/[(M_{A})+(M_{D})]=from 0.01 to 100 (preferably from 0.03 to 50, and more preferably from 0.05 to 20)

Within such a range of proportion, it is possible to more effectively cure the acrylic polymer (A) and to reveal more excellent cohesion.

Also, the proportion of the thermally expandable microspheres (C) can be selected within the range of from about 1 to 50 parts by weight (preferably from 3 to 25 parts by weight, and more preferably from 3 to 10 parts by weight) based on 100 parts by weight of the acrylic polymer (A).

The foregoing pressure-sensitive adhesive may be used as it stands, but various additives may be added, if desired. For example, for adjusting adhesion characteristics, known or customary tackiness imparting resins (such as rosin based resins, terpene based resins, petroleum resins, coumarone.indene resins, styrene based resins, and phenol based resins) may be compounded. Also, various known additives such as various stabilizers such as plasticizers, fillers inclusive of finely divided silica, colorants, UV absorbers, and antioxidants can properly be compounded as additives other than the tackiness imparting resins. The amount of any of these additives to be used may be the amount usually applied to acrylic pressure-sensitive adhesives.

Also, for obtaining more uniform pressure-sensitive adhesives, an adjusting solvent may be added to the pressure-sensitive adhesive. Though the adjusting solvent is not particularly limited, since the pressure-sensitive adhesive composition contains the compound containing a functional group with high polarity, it is preferable to use an organic solvent having high polarity such as ethyl acetate and toluene. The adjusting solvent can properly be selected depending upon the kinds of the acrylic polymer (A), the isocyanate based compound (B), the thermally expandable microspheres (C), and the amine based compound (D).

Such a pressure-sensitive adhesive can be prepared by mixing the acrylic polymer (A), the isocyanate based compound (B), the thermally expandable microspheres (C), the amine based compound (D), and various optional additives and dissolving the mixture in a varied organic solvent such as toluene and ethyl acetate. Incidentally, the foregoing organic solvent can be removed in the drying step during the formation of the pressure-sensitive adhesive layer.

[Tacky Dust Cleaner]

The tacky dust cleaner of the invention is provided with an expanded pressure-sensitive adhesive layer comprising the foregoing pressure-sensitive adhesive, and the expanded pressure-sensitive adhesive layer can be formed by coating the pressure-sensitive adhesive on a prescribed site and after drying, subsequently heating the resulting pressure-sensitive adhesive, thereby expanding the thermally expandable microspheres (C). That is, during the formation of the expanded pressure-sensitive adhesive layer, the coating step of the pressure-sensitive adhesive, the drying step and the expansion step can be carried out in a continuous process (on the same production line). Accordingly, according to the conventional technologies, two steps in which after drying and aging treatment, expansion is carried out were necessary, but in the invention, not only the drying step and the expansion step can be carried out in a continuous single process, but also tacky dust cleaners having quality characteristics (performance) comparable to the conventional products can be obtained. It may be considered that this is caused from the matter that the use of the amine based compound (D) (crosslinking assistant) effectively promotes crosslinking reaction.

Also, since the drying step and the expansion step can be continuously carried out on the same production line, such can greatly contribute to reduction in the costs.

Much more, nevertheless the tacky dust cleaner of the invention has a wound shape in a rolled state, the crosslinking reaction in the lengthwise direction of winding is made uniform, and a stable performance is obtained. As a matter course, the dust cleaning characteristics are at the same level as in conventional tacky dust cleaners requiring aging.

Incidentally, in the drying step, the acrylic polymer (A) is crosslinked with the isocyanate based compound (B) as a crosslinking agent (curing agent) and the amine based compound (D) as a crosslinking assistant (curing assistant), whereby the pressure-sensitive adhesive layer having a constant network is formed; and in the expansion step, the pressure-sensitive adhesive layer is expanded with the thermally expandable microspheres (C), whereby the expanded pressure-sensitive adhesive layer is formed.

In the foregoing coating step, known or customary coating methods of pressure-sensitive adhesives (such as a method of using a customary coater such as gravure coaters, reverse roll coaters, kiss roll coaters, dip roll coaters, bar coaters, knife coaters, and spray coaters and a method of using a brush) can be utilized.

Also, in the foregoing drying step, not only the pressure-sensitive adhesive is dried (removal of the organic solvent, etc.), but also the acrylic polymer (A) causes crosslinking reaction (curing reaction). Since as described above, the pressure-sensitive adhesive contains the acrylic polymer (A), the isocyanate based compound (B), and the amine based compound (D), even when no aging treatment is carried out, it is possible to make the crosslinking reaction sufficiently proceed only by the drying step, and even by subsequently carrying out the expansion step, it is possible to form the expanded pressure-sensitive adhesive layer having good quality characteristics.

In addition, in the expansion step, the thermally expandable microspheres (C) are expanded. Examples of the expansion method that can be utilized include a method in which the pressure-sensitive adhesive is passed through a drying zone (drying tower) set up at a temperature of the expansion initiation temperature of the thermally expandable microspheres (C) or higher; and a method in which the pressure-sensitive adhesive is brought into contact with heat rollers (heat metal rollers) set up at a temperature of the expansion initiation temperature of the thermally expandable microspheres (C) or higher. However, for reducing expansion unevenness or making free from expansion unevenness, a method of bringing the pressure-sensitive adhesive into contact with heat metal rollers is preferable.

Incidentally, in the invention, during the formation of the expanded pressure-sensitive adhesive layer, it is possible to carry out the drying step and the expansion step by the same drying tower. In this case, the setting temperature of the drying tower can be a temperature of the expansion initiation temperature of the thermally expandable microspheres (C) or higher. In the case where the drying step and the expansion step are provided individually, it is preferable to set up the temperature of the drying step at a temperature lower than the expansion initiation temperature of the thermally expandable microspheres (C). Accordingly, it is important to use a solvent that can be dried at a temperature lower than the expansion initiation temperature of the thermally expandable microspheres (C) as the organic solvent in the pressure-sensitive adhesive layer.

The thickness of the expanded pressure-sensitive adhesive layer is not particularly limited but can properly be used depending on the utility. In the thickness of the expanded pressure-sensitive adhesive layer, the thickness before expansion and after the drying step (thickness of the unexpanded pressure-sensitive adhesive layer) can be selected within the range of, for example, from about 5 to 300 μm (preferably from 10 to 50 μm). Also, the thickness after expansion (after the expansion step) (thickness of the expanded pressure-sensitive adhesive layer) can be selected within the range of, for example, from about 10 to 1,000 μm (preferably from 50 to 300 μm).

In the tacky dust cleaner of the invention, the expanded pressure-sensitive adhesive layer may be formed on at least one surface of a substrate. That is, the tacky dust cleaner may be formed from a tacky sheet comprising a substrate having the expanded pressure-sensitive adhesive layer formed on one surface or both surfaces thereof. The foregoing substrate is not particularly limited, but any substrates that are used usually used in tacky sheets or tapes are employable. Plastic films (or sheets) can suitably be used as the substrate. Accordingly, tacky films comprising a plastic film having the expanded pressure-sensitive adhesive layer formed on one surface or both surfaces thereof can suitably be used as the tacky dust cleaner. Examples of plastic materials of the plastic film include various resins (thermoplastic resins) such as polyolefin based resins such as polyethylene, polypropylene, and ethylene-propylene copolymers; polyester based resins such as polyethylene terephthalate; vinyl chloride based resins; vinyl acetate based resins; polyimide based resins; fluorocarbon based resins; and cellophane.

Also, examples of the substrate include papers such as craft papers and Japanese papers; expanded material sheets comprising an expanded material made of polyurethane, polychloroprene rubber, etc.; cloths such as woven fabrics and non-woven fabrics of single or mixed yarns made of a fibrous substances such as natural fibers, semi-synthetic fibers or synthetic fibers including Manila hemp, pulps, rayon, acetate fibers, polyester fibers, polyvinyl alcohol fibers, polyamide fibers, and polyolefin fibers; rubber sheets made of natural rubber, butyl rubber, etc.; and metallic foils such as aluminum foils and copper foils. The substrate may have any structure of a single-layered structure or a laminated structure. The substrate may be transparent, semi-transparent, or opaque. In addition, the surface of the substrate may be subjected to surface treatment such as corona treatment.

The thickness of the substrate can properly be selected depending on the purpose but is from about 10 to 500 μm (preferably from 20 to 100 μm, and more preferably from 30 to 60 μm).

Incidentally, in the case where the substrate is a plastic film, the plastic film may be any of a non-stretched film or a stretched film (a uniaxially stretched film or a biaxially stretched film), but is preferably a transversely uniaxially stretched film. When a transversely uniaxially stretched film is used as the substrate, after dust cleaning using the tacky dust cleaner, for example, cutting properties for cutting off a stained one layer (peripheral one layer) become good.

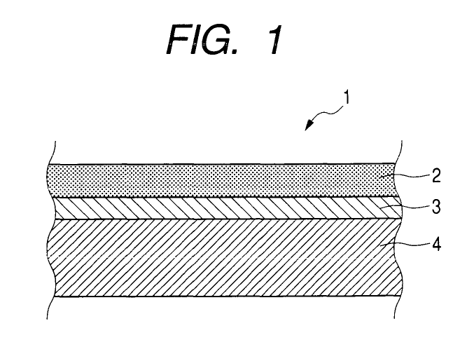

In the case where the tacky dust cleaner has a configuration in which the expanded pressure-sensitive adhesive layer is formed on at least one surface of the substrate (especially a plastic film), an antistatic layer may be formed between the expanded pressure-sensitive adhesive layer and the substrate, as shown in FIG. 1. By forming an antistatic layer, it is possible to suppress or prevent electrification to a material to be removed during the use of the tacky dust cleaner, or peeling electrification when, for example, a peripheral one layer of the tacky dust cleaner is peeled and removed after the use. FIG. 1 is a schematic sectional view to partially show one embodiment of the tacky dust cleaner of the invention. In FIG. 1, numerals 1, 2, 3 and 4 stand for a tacky dust cleaner, an expanded pressure-sensitive adhesive layer, an antistatic layer, and a substrate, respectively. The tacky dust cleaner 1 has a configuration in which the antistatic layer 3 and the expanded pressure-sensitive adhesive layer 2 are laminated in this order on one surface of the substrate 4.

The antistatic layer 3 can be formed from an antistatic agent. Any antistatic agents that are used as an antistatic agent in tacky sheets or tapes can be used without particular limitations. Examples of antistatic agents that can be used include cationic antistatic agents (such as quaternary ammonium salt type antistatic agents, quaternary ammonium resin type antistatic agents, and imidazoline type antistatic agents), ionically conductive polymers, and conductive fillers. The antistatic agents can be used singly or in admixture of two or more thereof. As the antistatic agent, a trade name “BONDEIP PA-100” (manufactured by Konishi Co., Ltd.) can suitably be used. Incidentally, the antistatic layer may be formed from a metallic foil or a metallic vapor-deposited film.

For example, the thickness of the antistatic layer is from about 0.01 to 10 μm (preferably from 0.04 to 5 μm).

Also, in the tacky dust cleaner, in the case where the expanded pressure-sensitive adhesive layer is formed on one surface of the substrate (especially a plastic film), a release treating layer may be provided on the surface of the substrate opposite to the surface on which the expanded pressure-sensitive adhesive layer is formed, or a release film (release liner) may be laminated on the expanded pressure-sensitive adhesive layer. By using such a release treating layer or release liner, it is possible to protect the expanded pressure-sensitive adhesive layer. The release treating layer can be formed from a release treating agent. Known or customary release treating agents such as silicone based releasing agents, fluorocarbon based releasing agents, and long chain alkyl based releasing agents can be used as the foregoing release treating agent. On the other hand, examples of release liners include release liners in which a release treating agent layer comprising the foregoing release treating agent is formed on the surface of a substrate; release liners comprising a plastic film having high releasability itself [such as polyolefin based resin-made films such as polyethylene films (e.g., linear low-density polyethylene films) and ethylene/α-olefin copolymer films; and films made of Teflon (a registered trade mark)]; and release liners obtained by laminating or coating the foregoing plastic film material having high releasability (such as polyolefin based resins such as polyethylenes and ethylene/α-olefin copolymers; and Teflon) on a varied substrate (such as metallic foils and heat resistant plastic films).

The shape of the tacky dust cleaner of the invention is not particularly limited but can properly take a sheet form or a tape form. In particular, a wound shape in a rolled state is preferable. In this case, a core is usually used. In the tacky dust cleaner having such a wound shape in a rolled state, it is usually wound around a core such that the expanded pressure-sensitive adhesive layer becomes outside (the surface side). That is, it is optimum that the tacky dust cleaner has a rolled state where it is wound around a core such that the expanded pressure-sensitive adhesive layer becomes outside. In the case where the tacky dust cleaner has such a wound shape in a rolled state, it is preferred that a release treating layer is formed on the surface of the substrate opposite to the surface on which the expanded pressure-sensitive adhesive layer is formed, and the release treating layer and the expanded pressure-sensitive adhesive layer are overlaid on each other and wound in a rolled state. Incidentally, the core may be a core constructed of any material such as plastic cores, paper cores, and metallic cores.

Incidentally, the expanded pressure-sensitive adhesive layer may be constituted of plural layers with or without via other layer within the range where the effects of the invention are not hindered. Also, the expanded pressure-sensitive adhesive layer may be provided on both surfaces of the substrate.

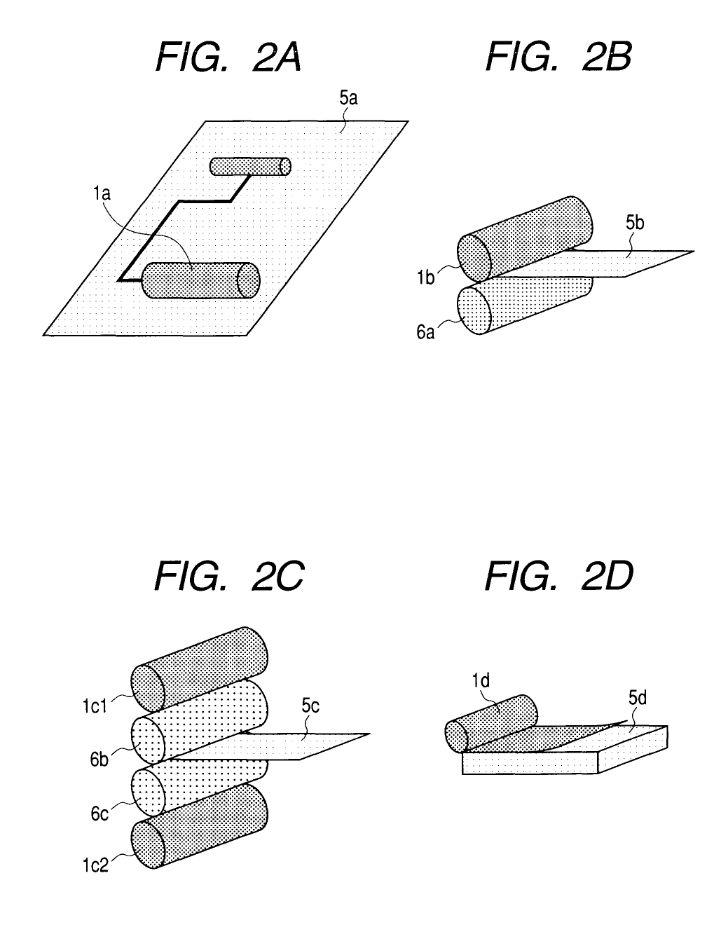

The tacky dust cleaner of the invention can be utilized as any type of tacky dust cleaner. Specifically, the tacky dust cleaner of the invention can be utilized as a hand roller type as shown in FIG. 2A; a direct transfer type as shown in FIG. 2B; a transfer type as shown in FIG. 2C; and a sticking type as shown in FIG. 2D. FIGS. 2A to 2D are schematic views to show embodiments of using the tacky dust cleaner of the invention. Specifically, in FIGS. 2A to 2D, FIG. 2A shows an embodiment of use regarding a hand roller type; FIG. 2B shows an embodiment of use regarding a direct transfer type; FIG. 2C shows an embodiment of use regarding a transfer type; and FIG. 2D shows an embodiment of use regarding a sticking type. In FIGS. 2A to 2D, numerals 1a, 1b, 1c1, 1c2 and 1d stand for a tacky dust cleaner; numerals 5a to 5d stand for a dust-attached material; a numeral 6a stands for a rubber roller or a metallic roller; a numeral 6b stands for a tacky rubber roller; and a numeral 6c stands for a tacky rubber roller. Incidentally, in FIGS. 2A to 2D, while dust-attached materials 5a to 5d in a sheet form (or a plate form) are shown as the dust-attached material, they may be of any shape and any material (such as electronic parts, receptacles, furniture, carpets, tatami mats, walls, and films during production).

According to the invention, it is possible to produce a tacky dust cleaner with high productivity and at low costs. Also, it has good quality characteristics.

The invention will be hereunder described in detail with reference to the following Examples, but it should not be construed that the invention is limited to these Examples.

### EXAMPLE 1

The following materials were respectively used as a pressure-sensitive adhesive and a substrate.

Pressure-Sensitive Adhesive:

A pressure-sensitive adhesive comprising a mixture of 100 parts by weight of an acrylic polymer (a butyl acrylate-acrylic acid copolymer; composition ratio: butyl acrylate/acrylic acid=100/5 (weight ratio); weight average molecular weight: 600,000), 3 parts by weight of a polyisocyanate based compound (a trade name “Coronate L” manufactured by Nippon Polyurethane Industry Co., Ltd.), 3 parts by weight of thermally expandable microspheres (a trade name “Matsumoto Microsphere F301D” manufactured by Matsumoto Yushi-Seiyaku Co., Ltd.; expansion initiation temperature: 90° C.), and 0.1 parts by weight of an amine based compound containing plural hydroxyl groups (a trade name “EDP-450” manufactured by Asahi Denka Co., Ltd.) dissolved in toluene

Substrate:

A transversely uniaxially stretched polypropylene-made film (thickness: 40 μm)

The foregoing pressure-sensitive adhesive was coated on one surface of the foregoing substrate using a coater (reverse coater) and after drying, was passed through a drying step set up at a condition of 85° C. (drying time: one minute). Incidentally, the pressure-sensitive adhesive layer after drying had a thickness of 40 μm.

Subsequently, the tacky film having been passed through the drying step was brought into contact with metallic rollers set up at 130° C. (contact time: 5 seconds) to expand the pressure-sensitive adhesive layer. Incidentally, the pressure-sensitive adhesive layer after expansion had a thickness of 80 μm.

The tacky film having been passed through the expansion step was wound up in a length of 1,000 m around a plastic core such that the expanded pressure-sensitive adhesive layer became outside, to prepare a tacky dust cleaner having a wound shape in a rolled state.

### COMPARATIVE EXAMPLE 1

A tacky dust cleaner having a wound shape in a rolled state was prepared in the same manner as in Example 1, except that the amine based compound containing plural hydroxyl groups (a trade name “EDP-450” manufactured by Asahi Denka Co., Ltd.) was not used and that after drying, the pressure-sensitive adhesive was subjected to aging treatment at normal temperature for 4 days and then expanded.

Evaluation Methods:

The tacky dust cleaners obtained in the Example and Comparative Example were evaluated in the following methods. The results are shown in Table 1.

(Measurement Method of Tackiness)

A tacky tape having a width of 25 mm by the tacky dust cleaner was stuck on a stainless steel plate (BA finished) in a method of reciprocating a 2-kg roller. After allowing it to stand for about 20 minutes, the resulting tacky tape was subjected to 180° peel-apart test (tensile rate: 300 mm/min., at 23° C. and at 50% RH) using a Tensilon tensile tester to measure a force necessary for peeling (180° peel force) (N/25 mm), thereby evaluating a tackiness (N/25 mm).

(Measurement Method of Dust Cleaning Rate)

The tacky dust cleaner wound in a rolled state was made one revolution over spread glass beads (mean particle size: about 50 μm) whose weight had been measured while applying a load of about 1 kg, and the weight of the glass beads transferred on the surface of the expanded pressure-sensitive adhesive layer of the tacky dust cleaner was then measured to determine a dust cleaning rate (%).

(Measurement Method of Irregularity Follow-Up Depth)

Carbon particulate powders were spread on the irregular surface of each of films having an irregularity depth of 30 μm and 100 μm, and the tacky dust cleaner wound in a rolled state was revolved thereon. Then, the removal state of the carbon particulate powders from the film having irregularities was visually observed, and the irregularity follow-up depth (μm) was evaluated from the removal state of the carbon particulate powders.

TABLE 1

| | | Comparative |
|---|---|---|
| | Example 1 | Example 1 |
| Tackiness (N/25 mm) | 2 | 1.5 |
| Dust cleaning rate | 90 | 82 |
| (%) | | |
| Irregularity follow- | Dust cleaning | Dust cleaning |
| up depth (μm) | was possible at | was possible at |
| | 100 μm. | 100 μm. |

It was confirmed from Table 1 that the tacky dust cleaner according to Example 1 has a dust cleaning performance equivalent to the tacky dust cleaner according to Comparative Example 1 (conventional tacky dust cleaner), even without performing aging treatment.

Incidentally, with respect to the tacky dust cleaner according to Example 1, quality characteristics (such as tackiness) were evaluated in a site in the peripheral side and in a site closed to the core (side in the central side). As a result, it could be confirmed that the both sites had equivalent characteristics.

While the invention has been described in detail and with reference to specific embodiments thereof, it will be apparent to one skilled in the art that various changes and modifications can be made therein without departing from the spirit and scope thereof.

What is claimed is:

1. A tacky dust cleaner having an expanded pressure-sensitive adhesive layer, the expanded pressure-sensitive adhesive layer being constituted of a pressure-sensitive adhesive comprising (A) an acrylic polymer containing an isocyanate group-reactive functional group, (B) a polyisocyanate based compound, (C) thermally expandable microspheres, and (D) an amine based compound containing plural hydroxyl groups.

2. The tacky dust cleaner according to claim 1, wherein the expanded pressure-sensitive adhesive layer is formed on at least one surface of a substrate.

3. The tacky dust cleaner according to claim 2, wherein an antistatic layer is formed between the expanded pressure-sensitive adhesive layer and the substrate.

4. The tacky dust cleaner according to claim 1, having a rolled state where it is wound around a core such that the expanded pressure-sensitive adhesive layer becomes outside.
